(19) United States
(12) Patent Application Publication
(10) Pub. No.: US 2013/0321124 A1
(43) Pub. Date: Dec. 5, 2013

(54) CONTROL DEVICE, UNDER-CONTROL DEVICE, CONTROL METHOD THEREOF, REMOTE CONTROL SYSTEM, AND RECORDING MEDIUM

(71) Applicants: Kazunori Shibata, Osaka-shi (JP); Akira Tojima, Osaka-shi (JP)

(72) Inventors: Kazunori Shibata, Osaka-shi (JP); Akira Tojima, Osaka-shi (JP)

(73) Assignee: SHARP KABUSHIKI KAISHA, Osaka-shi, Osaka (JP)

(21) Appl. No.: 14/000,910

(22) PCT Filed: Jul. 25, 2012
(86) PCT No.: PCT/JP2012/068804

§ 371 Date: Aug. 22, 2013

(30) Foreign Application Priority Data
Dec. 27, 2011 (JP) 2011-285840

(51) Int. Cl. G05B 1/01

(52) U.S. Cl. CPC G05B 1/01
USPC 340/5.6; 340/12.53

(57) ABSTRACT

By a user selecting a name of a device displayed in association with identification information identical to the identification information notified at an icon of an under-control device at a table of a control device, an under-control device subject to control by the control device can be selected while reliably identifying an under-control device.

### TECHNICAL FIELD

The present invention relates to a remote control system, particularly a remote control system including an under-control device connected on a network and a control device for remotely controlling the under-control device.

### BACKGROUND ART

Conventionally, various techniques are disclosed for remotely controlling a device. Recently, the technique for a user to operate a terminal at hand as a remote controller is adapted to practical use.

For example, PTD 1 (Japanese Patent Laying-Open No. 2002-186061) discloses the approach to select a device to be remotely controlled from a plurality of devices, and notifying the selection of a device by emitting light. Further, PTD 2 (Japanese Patent Laying-Open No. 2003-102073) discloses the approach to switch between a plurality of devices to be taken as the subject of control by a remote controller that can control a plurality of different devices.

### CITATION LIST

### Patent Document

PTD 1: Japanese Patent Laying-Open No. 2002-186061
PTD 2: Japanese Patent Laying-Open No. 2003-102073

### SUMMARY OF INVENTION

### Technical Problem

Conventionally, there was the case where the user cannot identify the device qualified as the control subject of a remote controller.

For example, in the case where a communication scheme absent of directivity such as WiFi (Wireless Fidelity) is employed as the communication means between the remote controller and the device that is the subject of control according to the approach disclosed in PTD 1, there is a possibility of several devices located at a room other than where the user is present (another room from the user) becoming the subject of control. Even if light or the like is emitted on the part of the relevant device, the user cannot visually perceive that light, disallowed from identifying the device that has become the subject of control.

The approach disclosed in PTD 2 is disadvantageous in that, although the type of device to be subject to control can be selected at the remote controller side, identification between devices of the same type, when there are a plurality thereof, cannot be made. In such a case, the user cannot identify the device that is the subject of control.

In view of the foregoing, an object of the present invention is to allow a user to reliably identify the device that is the subject of control.

### Solution to Problem

A control device according to the present invention remotely controls a plurality of under-control devices connected on a network. The control device includes a presence informing signal reception unit for receiving a presence informing signal transmitted from a plurality of under-control devices qualified as a control subject, an instruction signal transmission unit for transmitting to each under-control device from which a presence informing signal is received a signal instructing notification of information to identify a relevant under-control device, a notification unit for notifying information to be notified at each under-control device from which a presence informing signal is received, a registration unit for registering information to be notified at each under-control device from which a presence informing signal is received in association with each under-control device, an input unit for entering an instruction to select one information from the information notified for each under-control device from which a presence informing signal is received, and a selection unit for selecting, as a subject of remote control, an under-control device registered at the registration unit in association with the information selected by an instruction to the input unit.

Preferably, the notification unit causes a display device to display information to be notified at each under-control device from which a presence informing signal is received in association with a character string including a model name of each under-control device or in association with information entered at the input unit corresponding to a relevant under-control device.

Preferably, the control device further includes an authentication processing unit for transmitting, when transmission of authentication information is requested from an under-control device, information entered at the input unit in response to the request to the relevant under-control device, and receiving from the relevant under-control device permission information that is information indicating permission of remote control of the relevant under-control device. The selection unit selects an under-control device requesting transmission of authentication information as a subject of remote control on condition that the authentication processing unit has received the permission information.

Preferably, the authentication processing unit transmits, for every under-control device, information entered at the input unit in response to a request for transmitting authentication information, and receives the permission information from a relevant under-control device.

Preferably, the instruction signal transmission unit obtains information of a power state of each under-control device from which a presence informing signal is received, and transmits a signal instructing notification of information to identify a relevant under-control device to only an under-control device that is powered up.

Preferably, the instruction signal transmission unit transmits to each under-control device from which a presence informing signal is received a signal instructing ending of the notification on condition that the selection unit has selected an under-control device that is the subject of remote control.

Preferably, the registration unit receives information to be notified at each under-control device from which a presence informing signal is received from each under-control device, and registers information corresponding to the received information.

Preferably, the registration unit receives image information from each under-control device as information to be notified at each under-control device from which a presence informing signal is received.

Preferably, the instruction signal transmission unit transmits information to be notified at a relevant under-control device together with a signal instructing notification of information for identification to an under-control device.

Preferably, the instruction signal transmission unit transmits information differing from each under-control device as the information to be notified.

Preferably, the instruction signal transmission unit receives from an under-control device information to be notified at the relevant under-control device; and when the information to be notified that is received from a plurality of under-control devices is identical, transmits information differing from the notified information to at least one of the plurality of under-control devices as information to be notified at the relevant under-control device.

An under-control device according to the present invention is subject to remote control by a control device connected on a network. The under-control device includes a presence informing signal transmission unit for transmitting a presence informing signal periodically onto the network; and a notification unit for notifying, on condition that a signal instructing notification of information to identify the under-control device has been received from the control device, relevant information.

Preferably, the under-control device further includes an authentication information storage unit storing authentication information that is information to determine whether to permit the host device to be subject to remote control; a request transmission unit for transmitting information requesting transmission of authentication information to the control device; and a permission information transmission unit transmitting permission information permitting the host device to be subject to remote control to the control device on condition that information received according to transmission of information by the request transmission unit from the control device matches the authentication information.

Preferably, the under-control device further includes a notification contents storage unit storing information to be notified by the notification unit.

Preferably, the under-control device further includes a notification information transmission unit for transmitting information to be notified by the notification unit to the control device.

Preferably, the notification information transmission unit transmits image information as information to be notified by the notification unit.

Preferably, the under-control device further includes a determination unit for determining information to be notified by the notification unit in response to receiving the signal instructing notification from the control device.

Preferably, the notification unit receives information to identify an under-control device from the control device, and notifies the received information.

A remote control system according to the present invention includes an under-control device, and a control device remotely controlling a relevant under-control device, connected on a network. The under-control device includes a presence informing signal transmission unit for transmitting a presence informing signal periodically onto the network. The control device includes a presence informing signal reception unit for receiving a presence informing signal transmitted from a plurality of under-control devices, and an instruction signal transmission unit for transmitting to each under-control device from which a presence informing signal is received a signal instructing notification of information to identify a relevant under-control device. The under-control device further includes a first notification unit for notifying, on condition that a signal instructing notification of information to identify an under-control device has been received from the control device, the relevant information. The control device further includes a second notification unit for notifying information to be notified at each under-control device from which a presence informing signal is received; a registration unit for registering information to be notified at each under-control device from which a presence informing signal is received in association with each under-control device; an input unit for entering an instruction to select one information from the information notified by the second notification unit for each under-control device from which a presence informing signal is received; and a selection unit for selecting, as a subject of remote control, an under-control device registered at the registration unit in association with the information selected by the instruction to the input unit.

A control method of a control device according to the present invention is executed by a computer controlling a control device remotely controlling a plurality of under-control devices connected on a network. The control method of a control device includes the steps of: receiving a presence informing signal transmitted from a plurality of under-control devices qualified as a control subject; transmitting to each under-control device from which a presence informing signal is received a signal instructing notification of information to identify a relevant under-control device; notifying information to be notified at each under-control device from which a presence informing signal is received; registering information to be notified at each under-control device from which a presence informing signal is received in association with each under-control device, entering an instruction selecting one information from the information notified at each under-control device from which a presence informing signal is received; and selecting, as a subject of remote control, an under-control device registered in association with the information selected by the instruction entered.

A control method of an under-control device according to the present invention is executed by a computer controlling an under-control device subject to remote control by a control device connected on a network. The control method of an under-control device includes the steps of: transmitting a presence informing signal periodically onto the network; receiving from the control device a signal instructing notification of information to identify an under-control device; and notifying the information on condition that a signal instructing notification has been received.

A recording medium on which is stored a control program for a control device remotely controlling a plurality of under-control devices connected on a network according the present invention has the control program executed by a computer controlling the control device. The control program causes the computer to execute the steps of: receiving a presence informing signal transmitted from a plurality of under-control devices qualified as a control subject; transmitting to each under-control device from which a presence informing signal is received a signal instructing notification of information to identify a relevant under-control device; notifying information to be notified at each under-control device from which a presence informing signal is received; registering information to be notified at each under-control device from which a presence informing signal is received in association with each under-control device; entering an instruction to select one information from the information notified at each under-control device from which a presence informing signal is received; and selecting, as a subject of remote control, an under-control device registered in association with the information selected by the instruction entered.

A control program for an under-control device according to the present invention is executed by a computer controlling an under-control device subject to remote control by a control device connected on a network. The control program causes the computer to execute the steps of transmitting a presence informing signal periodically onto the network; receiving from the control device a signal instructing notification of information to identify an under-control device; and notifying the information on condition that the signal instructing notification has been received.

### Advantageous Effects of Invention

According to the present invention, information is notified at each under-control device, and the information notified at each under-control device is notified to a control device. By selecting one information from the notified information at the control device, the under-control device registered in association with relevant selected information is selected as the subject of remote control.

Accordingly, the user can reliably identify an under-control device subject to control.

### BRIEF DESCRIPTION OF DRAWINGS

FIG. 1 schematically represents an entire configuration of an embodiment of a remote control system according to the present invention.

FIG. 2 schematically represents a hardware configuration of a control device constituting the remote control system of FIG. 1.

FIG. 3 schematically represents a hardware configuration of an under-control device constituting the remote control system of FIG. 1.

FIG. 4 schematically represents the functional configuration of the control device and under-control device constituting the remote control system of FIG. 1.

FIG. 5 represents an exemplary appearance of the control device in FIG. 1.

FIG. 6 represents an exemplary appearance of the under-control device in FIG. 1.

FIG. 7 is a diagram to describe an overview of a process executed at the remote control system shown in FIG. 1.

FIG. 8 is a diagram to describe an overview of a process executed at the remote control system shown in FIG. 1.

FIG. 9 is a diagram to describe an overview of a process executed at the remote control system shown in FIG. 1.

FIG. 10 is a flowchart of an example of a process executed at the control device shown in FIG. 1.

FIG. 11 is a flowchart of an example of a process executed at the control device shown in FIG. 1.

FIG. 12 is a flowchart representing a modification of a process executed at the control device shown in FIG. 1.

FIG. 13 is a flowchart representing a modification of a process executed at the control device shown in FIG. 1.

FIG. 14 is a flowchart representing an example of a process executed at the under-control device shown in FIG. 1.

FIG. 15 is a flowchart representing an example of a process executed at the under-control device shown in FIG. 1.

FIG. 16 is a flowchart representing a modification of a process executed at the under-control device shown in FIG. 1.

FIG. 17 is a flowchart representing a modification of a process executed at the under-control device shown in FIG. 1.

FIG. 18 is a flowchart representing another modification of a process executed at the under-control device shown in FIG. 1.

FIG. 19 is a flowchart representing another modification of a process executed at the under-control device shown in FIG. 1.

### DESCRIPTION OF EMBODIMENTS

Embodiments of a remote control system according to the present invention will be described with reference to the drawings. In the description, elements having the same function and effect have the same reference characters allotted, and description thereof will not be repeated.

### First Embodiment

<System Entire Configuration>

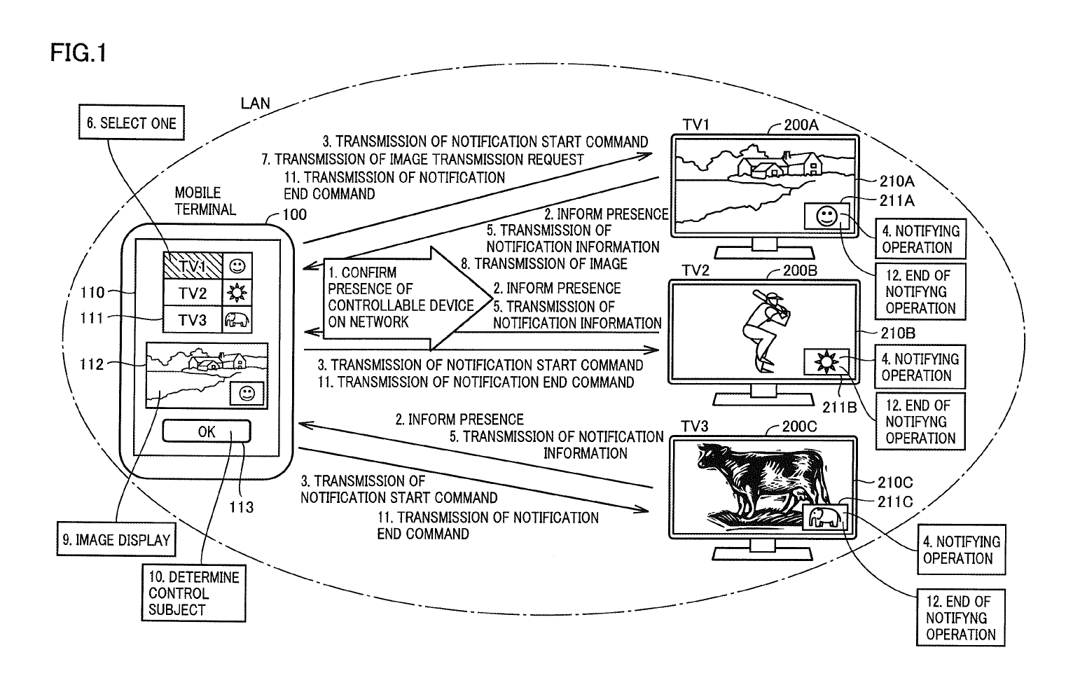

FIG. 1 schematically represents an entire configuration of an embodiment of a remote control system according to the present invention.

The remote control system shown in FIG. 1 includes under-control devices 200A, 200B, and 200C, and a control device 100 remotely controlling the operation thereof. In the present embodiment, a television is employed as a specific example of under-control devices 200A, 200B, and 200C, and a portable information terminal is employed as a specific example of control device 100. These are merely a way of example, and the under-control device and control device of the present invention are not limited thereto. In the present specification, under-control devices 200A, 200B, and 200C may also be generically referred to as under-control device 200.

In the remote control system of FIG. 1, control device 100 and under-control devices 200A, 200B, and 200C constitutes a LAN (Local Area Network). Control device 100 and under-control devices 200A, 200B, and 200C are configured connectable on the aforementioned network in a well-known manner such as IEEE (The Institute of Electrical and Electronic Engineers) 802.11 wireless communication, Bluetooth (registered trademark), Ethernet (registered trademark), and the like.

Although the exemplary configuration of the remote control system shown in FIG. 1 has three under-control devices 200A, 200B and 200C, the number of under-control devices 200 in the remote control system is not limited thereto.

<Process Overview in System>

In FIG. 1, the transfer of information between control device 100 and under-control device 200 is indicated by a description having a number such as “1 . . . ” allotted. These contents of transfer between these devices will be described hereinafter.

When an application for remote control is activated at control device 100 in the remote control system of the present invention, control device 100 first confirms whether there is a controllable apparatus (device) on the network (1. Confirm whether there is a controllable device on network). Specifically, control device 100 transmits an instruction to transmit a presence informing signal to a device subject to remote control by control device 100 in a broadcast.

In response, each of under-control devices 200A, 200B, and 200C transmits its own presence informing signal onto the network (“2. Inform presence”).

Upon receiving the aforementioned presence informing signal from each of under-control devices 200A, 200B, and 200C, control device 100 transmits a command (notification start command) instructing initiation of notifying information specific to itself to each of under-control devices 200A, 200B, and 200C transmitting a presence informing signal (“3. Transmission of notification start command”). Control device 100 obtains the IP (internet protocol) address of each under-control device 200 from the presence informing signal of each of under-control devices 200A, 200B and 200C. Control device 100 transmits a notification start command with the IP address of each under-control device 200 as the destination of transmission.

When under-control devices 200A, 200B and 200C receive a notification start command, a notifying operation is initiated (“4. Notifying operation”). Specifically, under-control devices 200A, 200B and 200C include display units 210A, 210B and 210C. Display units 210A, 210B and 210C show a picture received by each of under-control devices 200A, 200B and 200C. At under-control devices 200A, 200B and 200C, icons 211A, 211B and 211C are displayed on the screen of display units 210A, 210B and 210C. Icons 211A, 211B and 211C represent an image specific to each of under-control devices 200A, 200B and 200C. Specifically, an image of a smile is displayed as icon 211A of under-control device 200B. An image of the sun is displayed as icon 211B of under-control device 200B. An image of an elephant is displayed as icon 211C of under-control device 200C. This display of icons 211A, 211B and 211C corresponds to the notification of information specific to itself at each of under-control devices 200A, 200B and 200C.

Under-control devices 200A, 200B and 200C carries out notification of information specific to itself, in addition to the essential function of each device (in the case of a television, the function to display received video, and output received audio). Such notified information is referred to as “identification information” in the present specification.

Under-control devices 200A, 200B and 200C transmit to control device 100 information notified at the host device to control device 100 (“5. Transmission of notification information”), subsequent to starting notification of information specific to itself. The information transmitted at this stage may be information per se notified at under-control devices 200A, 200B and 200C (for example, image data when an image is displayed), or a code corresponding to the notified information. In the latter case, information that can be notified at under-control device 200 is stored in association with a code for identifying each information at control device 100. Control device 100 identifies information currently notified at each device based on the code received from each device.

Accordingly, control device 100 stores each information currently notified at under-control devices 200A, 200B and 200C in association with information directed to identification therebetween. Specifically, when a model name and IP address of each under-control device 200 are received as a presence informing signal, the model name, IP address, and information to be notified at each device (identification information) are stored in association for each device.

Control device 100 can also store for each device a name entered by the user for each device in association.

Control device 100 notifies in association the model name and information notified at each device, among the information stored in association. At this stage, control device 100 can notify the aforementioned name of each device input instead or in addition to the model name. Control device 100 of the present embodiment includes a display unit 110. An associated table 111 in display unit 110 of control device 100 shown in FIG. 1 is an example of notification carried out at control device 100. In associated table 111, “TV1”, “TV2”, and “TV3” are the names entered by the user for each device. In associated table 111, each of the names is displayed, aligned with a corresponding one of icons 211A, 211B and 211C displayed in display units 210A, 210B and 210C, respectively.

Control device 100 compares the information notified at each device, transmitted from each under-control device 200. When the information transmitted from two or more under-control devices 200 is identical, an instruction is given to relevant under-control devices 200 to modify the notifying information. Under-control device 200 receiving this instruction newly transmits to control device 100 information differing from information previously transmitted to control device 100 as the information to be notified.

Control device 100 does not have to transmit a modification instruction to all under-control devices 200 that have transmitted the same information. One of such under-control devices 200 can be selected by a well-known method (for example, select the device first receiving the information notified at each device), and transmit the aforementioned modification instruction to all the devices other than that selected device.

This process of control device 100 to cause an under-control device 200 to modify the information notified is continued until all under-control devices 200 in the remote control system notify different information. Accordingly, all under-control devices 200 in the remote control system of the present invention notify information differing from each other as identification information by a notification start command from control device 100.

In the case where control device 100 has caused under-control device 200 to modify the identification information by the above-described method, control device 100 transmits a notification start command again so as to notify the modified identification information.

Control device 100 may cause an under-control device 200 having identification information matching that of another under-control device 200 to select another information to be transmitted to control device as a candidate of the next identification information, or control device 100 itself may determine the identification information for a relevant under-control device 200, and instruct that under-control device 200 to notify the determined identification information. When the contents of identification information for an under-control device 200 are determined on the part of control device 100, control device 100 may transmit data of the relevant identification information per se to that under-control device 200, or a code corresponding to the relevant identification information may be transmitted to that under-control device 200. In the latter case, a code and information to be notified are stored in association at under-control device 200. Under-control device 200 specifies information to be notified, based on a code corresponding to instruction of notification from control device 100 to notify the relevant information as identification information, such as icon 211A.

Control device 100 has the name and identification information of each under-control device 200 displayed in association at associated table 111, as set forth above. When the user performs an operation of selecting the name of one under-control device 200 in associated table 111, information indicating the operating state of the selected under-control device 200 is notified, in addition to associated table 111, in display unit 110.

Specifically, an operation to select an under-control device 200A (TV1) in associated table 111 is performed at control device 100 (“6. Select one”). In response, control device 100 requests selected under-control device 200A to transmit the contents displayed at display unit 210A of under-control device 200A (7. Transmission of image transmission request). In response, under-control device 200A receiving the request transmits to control device 100 the image displayed at display unit 210A (8. Transmission of image). In response, control device 100 displays the image received from under-control device 200A as a screen 112 below associated table 111 on display unit 110 (“9. Image display”).

By selecting the name of one or more under-control devices 200 displayed together with the identification information in associated table 111 at control device 100, the operating contents of selected under-control device 200 can be confirmed at display unit 110. In the aforementioned example, under-control device 200 is a television. The screen displayed at that television is notified as the operating contents at control device 100. In the case where the under-control device is another type of device, the operating contents may be notified in a different manner. For example, in the case where the under-control device is an air conditioner, control device 100 requests that air conditioner to transmit the air flow amount, set temperature, and the like as the operation contents, and notifies the air flow amount, set temperature, and the like transmitted from the under-control device in response to the request as the operation contents of the relevant under-control device.

Also, a determination button 113 is displayed at the display unit 110 of control device 100. Upon manipulation on determination button 113, the under-control device having the operating contents notified at that point in time, as indicated as screen 112, is selected as the subject of control at control device 100. By the selection of an under-control device as the subject of control at control device 100, the next operation for executing remote control of the relevant under-control device, such as displaying a screen at display unit 110 for operating the relevant under-control device, is executed.

Furthermore, upon determining the device subject to control, control device 100 transmits a notification end command (“11. Transmit notification end command”) to under-control device 200 to which the aforementioned “notification start command” has been transmitted. The notification end command instructs termination of notifying the identification information. In response, the display of icons 211A, 211B and 211C at under-control devices 200A, 200B and 200C, respectively, ends

At control device 100 in the remote control system set forth above, notification of identification information is instructed to each of under-control devices 200A, 200B and 200C from which a presence informing signal is received, and identification information notified at each of under-control devices 200A, 200B and 200C is notified at control device 100 in association with under-control devices 200A, 200B and 200C. Then, at control device 100, the user selects any of the names of under-control devices 200A, 200B and 200C notified in association with the identification information, and manipulates determination button 113 to take any of under-control devices 200A, 200B and 200C selected as the subject of remote control by control device 100.

According to the remote control system of the present embodiment, the user selects a name, from associated table 111 of control device 100, associated with identification information identical to that notified in icons 211A, 211B and 211C of under-control devices 200A, 200B and 200C. Therefore, the user can select an under-control device 200 subject to control at control device 100 while reliably identifying an under-control device 200.

In the present embodiment, the user can associate each name in associated table 111 with each of under-control devices 200A, 200B and 200C by checking associated table 111 that notifies identification information identical to that notified at each under-control device 200. By confirming the operating contents of each under-control device 200 through screen 112, each device in associated table 111 can be associated with each of under-control devices 200A, 200B and 200C more reliably.

The contents of the identification information once ascertained at each under-control device 200 is preferably not changed for each under-control device 200 as long as a process to modify the contents is not performed. Accordingly, once the user memorizes the contents of identification information corresponding to an under-control device 200, the user can select an appropriate under-control device 200 as the subject of remote control through control device 100 by just looking at the name and/or identification information of a relevant under-control device 200 displayed in associated table 111 at control device 100 thereafter.

Notification of identification information of each under-control device 200 carried out for identifying the subject of control (display of icons 211A, 211B and 211C in the present embodiment) ends, after determining the subject of control, by transmitting a notification end command. Therefore, the period of time during which notification of such information is made is suppressed as short as possible.

In the case where authentication is required for control at each under-control device 200, the user can receive authentication from each under-control device 200 by entering a password at control device 100 at various timing. For example, when under-control device 200 requests for transmission of a password in response to transmission of a notification start command according to “3. Transmission of notification start command”, control device 100 requests for entry of a password at display unit 110. Control device 100 transmits the password entered by the user to relevant under-control device 200. In response, under-control device 200 authenticates the password. When the authentication succeeds, identification information is notified together with the information indicating that the authentication has succeeded (“4. Notifying operation”). Then, the image displayed at the host device is transmitted to control device 100 (5. Transmission of notification information). When authentication fails in this case, under-control device 200 transmits information indicating authentication failure to control device 100 without notifying the identification information and without transmitting the image currently displayed at the host device.

Under-control device 200 may skip transmission of information indicating that authentication has succeeded. In other words, the aforementioned transmission of an image to control device 100 (“5. Transmission of notification information”) is relevant to substantially transmitting information indicating that authentication has succeeded.

The password, when once entered, may be stored at control device 100. When transmission of a password is requested from under-control device 200 and the password has already been entered and stored at control device 100, control device 100 will not request the user to enter a password, and transmits the stored password to under-control device 200. Thus, by just entering the password once at control device 100, the user can operate under-control device 200 in the remote control system by means of control device 100.

<Hardware Configuration>

(Hardware Configuration of Control Device)

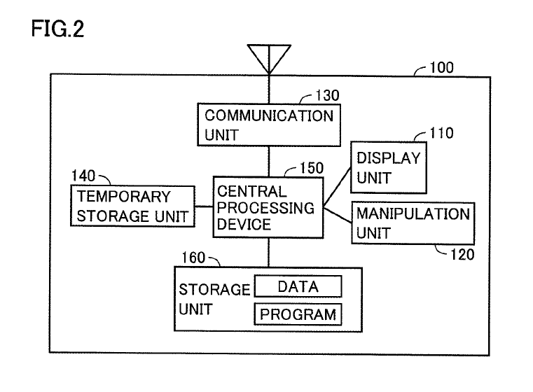

FIG. 2 represents a specific example of a hardware configuration of control device 100.

Referring to FIG. 2, control device 100 includes a central processing device 150 for the overall control of control device 100. Central processing device 150 includes an operation device such as a central processing unit (CPU). Control device 100 includes a temporary storage unit 140 serving as a work region during execution of a program at central processing device 150. Temporary storage unit 140 is a main memory such as a random access memory (RAM), and the like.

Control device 100 further includes a display unit 110 implemented by a display device such as a liquid crystal display, manipulation unit 120 for accepting manipulation entry on control device 100, a storage unit 160 for storing a program and various data to be executed at central processing device 150, and a communication unit 130 formed of a modem and the like for communication control via a network such as the aforementioned LAN. Communication unit 130 communicates onto the network in a well-known manner such as IEEE 802.11 wireless communication, Bluetooth (registered trademark), Ethernet (registered trademark), and the like. Manipulation unit 120 is implemented by an input device such as a keyboard and/or mouse. Manipulation unit 120 is implemented by a touch sensor, and may be implemented as a touch panel integral with display unit 110.

In the present embodiment, the function of control device 100 set forth in the present specification is at least partially implemented by central processing device 150 executing an appropriate program.

The program executed by central processing device 150 may be stored in the aforementioned recording medium. For the recording medium, a medium storing a program in a non-volatile manner such as a CD-ROM (Compact Disc-Read Only Memory), DVD-ROM (Digital Versatile Disk-Read Only Memory), USB (Universal Serial Bus) memory, memory card, FD (Flexible Disk), hard disk, magnetic tape, cassette tape, MO (Magnetic Optical Disc), MD (Mini Disc), IC (Integrated Circuit) card (excluding memory card), optical card, mask ROM, EPROM, EEPROM (Electronically Erasable Programmable Read-Only Memory) and the like can be cited. The program executed by central processing device 150 may be installed in storage unit 160 via the network.

(Hardware Configuration of Under-Control Device)

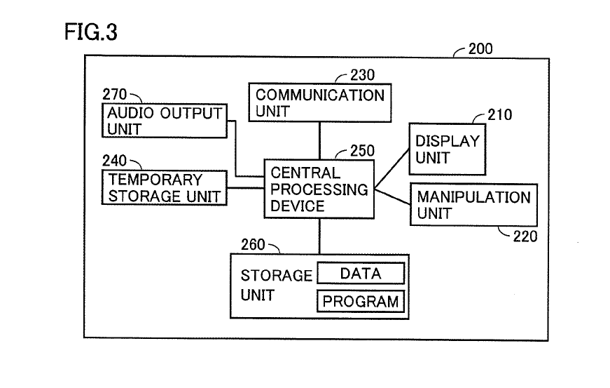

FIG. 3 represents a specific example of a hardware configuration of under-control device 200.

Referring to FIG. 3, under-control device 200 includes a central processing device 250 for overall control of under-control device 200. Central processing device 250 includes an operation device such as a CPU.

Under-control device 200 includes a storage unit 260 for storing a program and various data executed at central processing device 250, a temporary storage unit 240 serving as a work region during execution of a program at central processing device 250, a display unit 210 (generic designation of display units 210A, 210B and 210C) constituted of a display device such as a liquid crystal display, an audio output unit 270 implemented by a speaker or the like providing audio, a manipulation unit 220 for accepting manipulation entry on under-control device 200, and a communication unit (modem and the like) 230 for connection on the aforementioned LAN. Communication unit 230 communicates on the network in a well-known manner such as IEEE 802.11 wireless communication, Bluetooth (registered trademark), Ethernet (registered trademark), and the like (Bluetooth).

In the present embodiment, the function of under-control device 200 set forth in the present specification is at least partially implemented by central processing device 250 executing an appropriate program.

Manipulation unit 220 is implemented by an input device such as a keyboard and/or mouse. Manipulation unit 220 is implemented by a touch sensor, and may be implemented as a touch panel integral with display unit 24.

The program executed by central processing device 150 may be stored in the aforementioned recording medium. For the recording medium, a medium storing a program in a non-volatile manner such as a CD-ROM, DVD-ROM, USB memory, memory card, FD, hard disk, magnetic tape, cassette tape, MO, MD, IC card (excluding memory card), optical card, mask ROM, EPROM, EEPROM and the like can be cited. The program executed by central processing device 250 may be installed in storage unit 260 via the network.

<Functional Configuration of Each Element in Remote Control System>

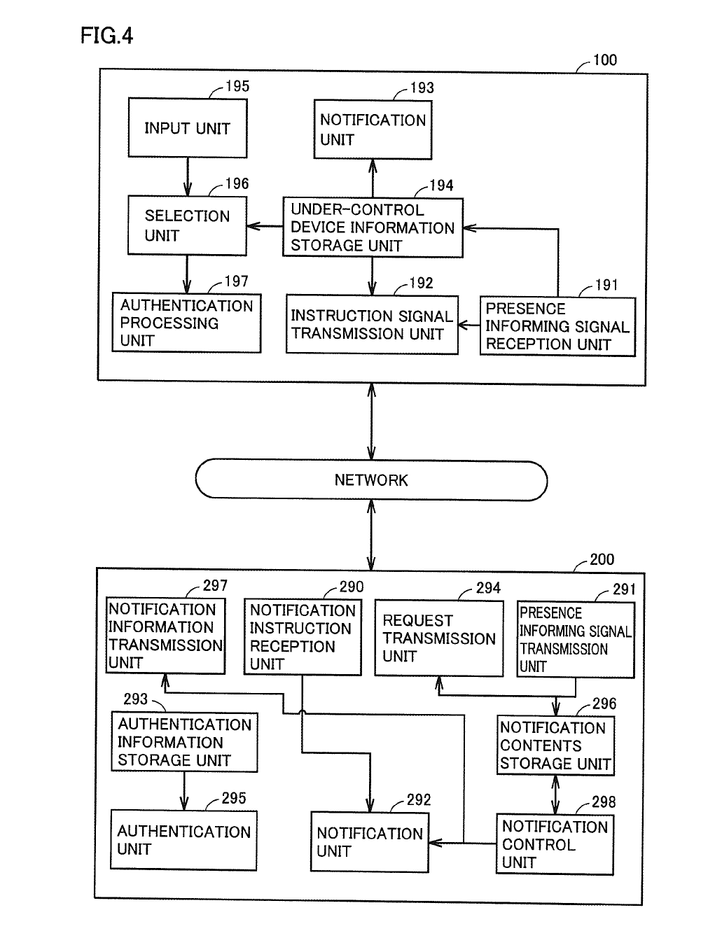

FIG. 4 schematically represents the functional configuration of control device 100 and under-control device 200 constituting the remote control system of FIG. 1. In the remote control system, under-control device 200 (under-control devices 200A, 200B and 200C), and control device 100 remotely controlling under-control device 200 are configured in a connectable manner on the network. Each function of control device 100 and under-control device 200 will be described hereinafter with reference to FIG. 4.

(Functional Configuration of Control Device)

Control device 100 includes a presence informing signal reception unit 191 for receiving a presence informing signal transmitted from a plurality of under-control devices 200A, 200B and 200C qualified as a control subject. Presence informing signal reception unit 191 is implemented mainly by communication unit 130.

Control device 100 includes an instruction signal transmission unit 192 for transmitting, to each of under-control devices 200A, 200B and 200C from which a presence informing signal is received, a signal instructing notification of information to identify under-control devices 200A, 200B and 200C. Instruction signal transmission unit 192 is implemented mainly by central processing device 150 and communication unit 130.

Control device 100 includes a notification unit 193 for notifying information to be notified at each of under-control devices 200A, 200B and 200C from which a presence informing signal is received. Notification unit 193 is implemented mainly by central processing device 150 and display unit 110.

Control device 100 also includes an under-control device information storage unit 194 for registering information to be notified at each of under-control devices 200A, 200B and 200C from which a presence informing signal is received in association with each of under-control devices 200A, 200B and 200C (model name or the like). Under-control device information storage unit 194 is implemented mainly by storage unit 160.

Control device 100 also includes an input unit 195 for entering an instruction to select one information from the information notified for each of under-control devices 200A, 200B and 200C from which a presence informing signal is received. Input unit 195 is implemented mainly by manipulation unit 120.

Control device 100 also includes a selection unit 196 for selecting, as a subject of remote control, under-control devices 200A, 200B and 200C registered in under-control device information storage unit 194 in association with the information selected by an instruction to input unit 195. Selection unit 196 is implemented mainly by central processing device 150.

At control device 100, notification unit 193 causes the display device to display the information notified at each of under-control devices 200A, 200B and 200C from which a presence informing signal is received in association with a character string including a model name of each of under-control devices 200A, 200B and 200C, or in association with information entered at input unit 195 corresponding to a relevant one of under-control devices 200A, 200B and 200C. Although the display device is implemented mainly by display unit 110 here, the display device may be provided in control device 100 or provided individually to control device 100. In the case of an individual device, central processing device 150 instructs the external display device to provide a display such as associated table 111.

In the case where information for authentication such as a password is requested by under-control device 200, control device 100 transmits information entered by the user through manipulation unit 120 to a relevant under-control device 200. In response, information of whether authentication has succeeded or failed is transmitted from under-control device 200 to control device 100. Accordingly, control device 100 includes an authentication processing unit 197 for transmitting, when transmission of authentication information is requested by under-control devices 200A, 200B and 200C, information entered at input unit 195 in response to the request to relevant under-control devices 200A, 200B and 200C, and receiving from under-control devices 200A, 200B and 200C permission information that is information permitting remote control of relevant under-control devices 200A, 200B and 200C. Authentication processing unit 197 transmits a password, and receives information as to whether authentication has succeeded or failed. Authentication processing unit 197 is implemented mainly by communication unit 130.

In the case where a password is set for under-control device 200 in the remote control system of the present embodiment and control device 100 cannot transmit a proper password to relevant under-control device 200, control device 100 will not receive authentication from under-control device 200, such that notification of information notified at relevant under-control device 200 cannot be received and the relevant under-control device cannot be set as the subject of remote control. In other words, selection unit 196 in control device 100 selects under-control devices 200A, 200B and 200C requesting transmission of authentication information as the subject of remote control on condition that permission information is received from authentication processing unit 197.

The password set at under-control device 200 may differ for each of under-control devices 200A, 200B and 200C. In other words, authentication processing unit 197 may transmit information entered at input unit 195 in response to a request for transmitting authentication information for each of under-control devices 200A, 200B and 200C, and receive permission information from relevant under-control devices 200A, 200B and 200C.

In this case, the passwords entered for each of under-control devices 200A, 200B and 200C may be stored in storage unit 160 at control device 100. In addition to the storage of a model name, IP address, and identification information in association for each of under-control devices 200A, 200B and 200C, control device 100 may have the password entered for each device also stored. When a password request is received from each of under-control devices 200A, 200B and 200C, instruction signal transmission unit 192 (central processing device 150) of control device 100 transmits a password stored in association with the device issuing the request.

Control device 100 can obtain an ON/OFF state of the power for each under-control device 200 based on whether a presence informing signal has been received or not, when transmission of a presence informing signal is requested periodically to each under-control device 200, or the contents of the signal received from each under-control device 200. For example, when a presence informing signal is no longer received from an under-control device 200 from which a presence informing signal was received once, control device 100 determines that the power of relevant under-control device 200 has been turned OFF. The transmission of a notification start command (“3. Transmission of notification start command” in FIG. 1) is preferably carried out for only an under-control device 200 determined to have power turned ON. In other words, instruction signal transmission unit 192 at control device 100 may obtain information of the powered state for each of under-control devices 200A, 200B and 200C from which a presence informing signal is received, and transmit a signal instructing notification of information to identify between relevant under-control devices 200A, 200B and 200C, to only any of under-control devices 200A, 200B and 200C powered ON.

Further, there is the case where instruction signal transmission unit 192 transmits a signal instructing the termination of notification to each of under-control devices 200A, 200B and 200C from which a presence informing signal is received on condition that under-control devices 200A, 200B and 200C that are subject to remote control are selected by selection unit 196.

In the remote control system, the contents of identification information notified at under-control devices 200A, 200B and 200C may be determined on the part of under-control devices 200A, 200B and 200C, or on the part of control device 100. In the case where the contents are determined on the part of under-control devices 200A, 200B and 200C, reception of a notification start command causes each of under-control devices 200A, 200B and 200C to notify the identification information set at each of under-control devices 200A, 200B and 200C in advance, or specified by a user at each of under-control devices 200A, 200B and 200C. In this case, under-control device information storage unit 194 of control device 100 receives from each of under-control devices 200A, 200B and 200C information to be notified at each of under-control devices 200A, 200B and 200C from which a presence informing signal is received, and registers information corresponding to the received information.

The identification information may be voice audio information, or may be image information.

When identification information for each under-control device 200 is to be determined at control device 100, control device 100 determines the contents of identification information to be notified at each under-control device 200 according to the order of receiving a presence informing signal, or by an entered instruction from the user. Then, the determined identification information is transmitted to each under-control device 200. In other words, there is the case where instruction signal transmission unit 192 transmits to under-control devices 200A, 200B and 200C information to be notified at relevant under-control devices 200A, 200B and 200C together with a signal instructing notification of information for identification. As used herein, “together with a signal instructing notification” means that a signal instructing notification and information to be notified are transmitted from control device 100 to under-control device 200. However, this does not mean that these signals are necessarily transmitted at the same timing.

In this case, control device 100 transmits information differing from each of control devices 200A, 200B and 200C as identification information.

Control device 100 transmits identification information determined for each under-control device 200 together with a command instructing setting as the identification information of a relevant under-control device 200 (notifying operation contents setting command).

The transmitted information may be voice information and/or image information per se, or may be information such as a code that can specify audio information and image information.

In the case where the contents of identification information are determined on the part of under-control device 200, control device 100 performs a process to avoid identical identification information at all under-control devices 200. For example, control device 100 transmits an instruction to modify the identification information to an under-control device 200 having the same identification information. Namely, instruction signal transmission unit 192 receives information notified at relevant under-control devices 200A, 200B and 200C from under-control devices 200A, 200B and 200C, and when the notifying information received from under-control devices 200A, 200B and 200C are identical, transmits to at least one of the plurality of under-control devices 200A, 200B and 200C information differing from the notified information, as the information to be notified at relevant under-control devices 200A, 200B and 200C.

(Function Configuration of Under-Control Device)

Since the function according to the present embodiment is common between under-control devices 200A, 200B and 200C, the function of under-control devices 200A, 200B and 200C will be described as the function of under-control device 200.

Under-control device 200 may transmit a presence informing signal periodically on to the network. In this case, under-control device 200 includes a presence informing signal transmission unit 291. Presence informing signal transmission unit 291 is implemented mainly by central processing device 250 and communication unit 230.

In the case where under-control device 200 transmits a presence informing signal periodically, the process of requesting transmission of a presence informing signal by control device 100, indicated as “1.” in FIG. 1, may be omitted.

Under-control device 200 also includes a notification unit 292 for notifying information to identify between under-control devices 200A, 200B and 200C, on condition that a signal instructing notification of information for identifying under-control devices 200A, 200B and 200C is received from control device 100. Notification unit 292 is implemented mainly by display unit 210 displaying icon 211 (generic representation of icons 211A, 211B, and 211C) and/or audio output unit 270 providing audio.

Under-control device 200 further includes a notification instruction reception unit 290 receiving such an instruction from control device 100. Notification instruction reception unit 290 is implemented mainly by communication unit 230.

Under-control device 200 may be provided with the function to authenticate a user through a password or the like. Namely, under-control device 200 may include an authentication information storage unit 293 storing authentication information that is the information to determine whether to permit the host device to be subject to remote control. Authentication information storage unit 293 is realized by storage unit 260.

When authentication function is provided, under-control device 200 includes a request transmission unit 294 for transmitting information requesting transmission of authentication information to control device 100. Request transmission unit 294 is implemented mainly by central processing device 250 and communication unit 230.

When authentication function is provided, under-control device 200 includes an authentication unit 295 transmitting, on condition that information received from control device 100 in response to transmission of information by request transmission unit 294 is identical to the authentication information, the permission information permitting the host device to be subject to remote control to control device 100. Authentication unit 295 is implemented mainly by central processing device 250.

There is the case where under-control device 200 stores the contents of information notified as identification information. In this case, always the same contents are notified as the identification information at under-control device 200. In other words, under-control device 200 includes notification contents storage unit 296 storing information notified by notification unit 292. Notification contents storage unit 296 is implemented mainly by storage unit 260.

When identification information is determined on the part of under-control device 200, the determined identification information is transmitted to control device 100. Specifically, under-control device 200 may include a notification information transmission unit 297 for transmitting information notified by notification unit 292 to control device 100. Notification information transmission unit 297 is implemented mainly by central processing device 250 and communication unit 230.

When identification information is transmitted to control device 100 from under-control device 200, image information and/or audio information per se, or information of a code for specifying the same, is transmitted as identification information.

At under-control device 200, the identification information determined as set forth above is notified in response to receiving a notification start command from control device 100. Specifically, under-control device 200 includes a notification control unit 298 for determining information to be notified by notification unit 292 in response to receiving a signal instructing notification from control device 100. Notification control unit 298 is implemented mainly by central processing device 250.

At under-control device 200, there is the case where the identification information having the contents determined at control device 100 is received from control device 100 and notified. In this case, identification information from control device 100 is received by notification instruction reception unit 290. Accordingly, notification unit 292 receives from control device 100 information to identify between under-control devices 200A, 200B and 200C, and notifies the received information.

<Appearance of Device>

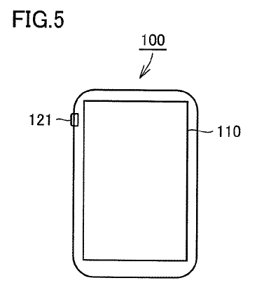

FIG. 5 represents an exemplary appearance of control device 100 shown in FIG. 1.

Referring to FIG. 5, control device 100 has display unit 110 provided at the outer surface. Further, manipulation button 121 to be manipulated by a user is provided at a side face of the casing of control device 100. Manipulation button 121 is included in manipulation unit 120, functioning as a power button and the like.

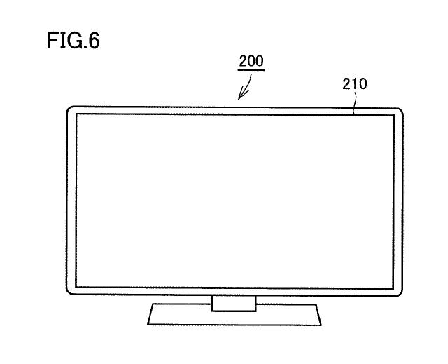

FIG. 6 represents an exemplary appearance of under-control device 200 shown in FIG. 1.

Referring to FIG. 6, under-control device 200 has a display unit 210 provided at the outer surface. A button to be manipulated by a user is provided at a side face of the casing of under-control device 200.

<Overview of Remote Control Subject Determination Process>

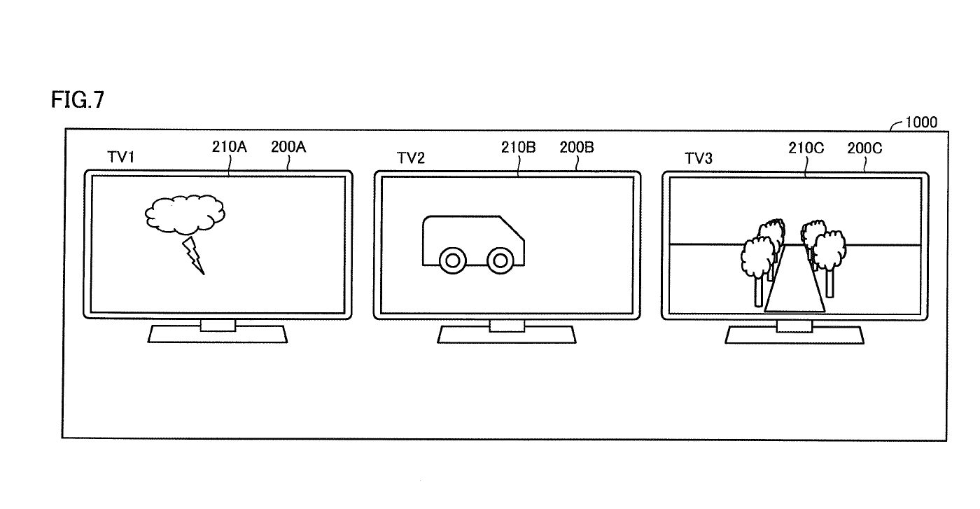

The process to determine the device to become the subject of remote control by control device 100 (remote control subject determination process) in the remote control system of the present invention will be described hereinafter with reference to FIGS. 7-9.

Referring to FIG. 7 first, each of under-control devices 200A, 200B and 200C displays a picture at each of display units 210A, 210B and 210C, respectively, according to a received signal in remote control system 1000.

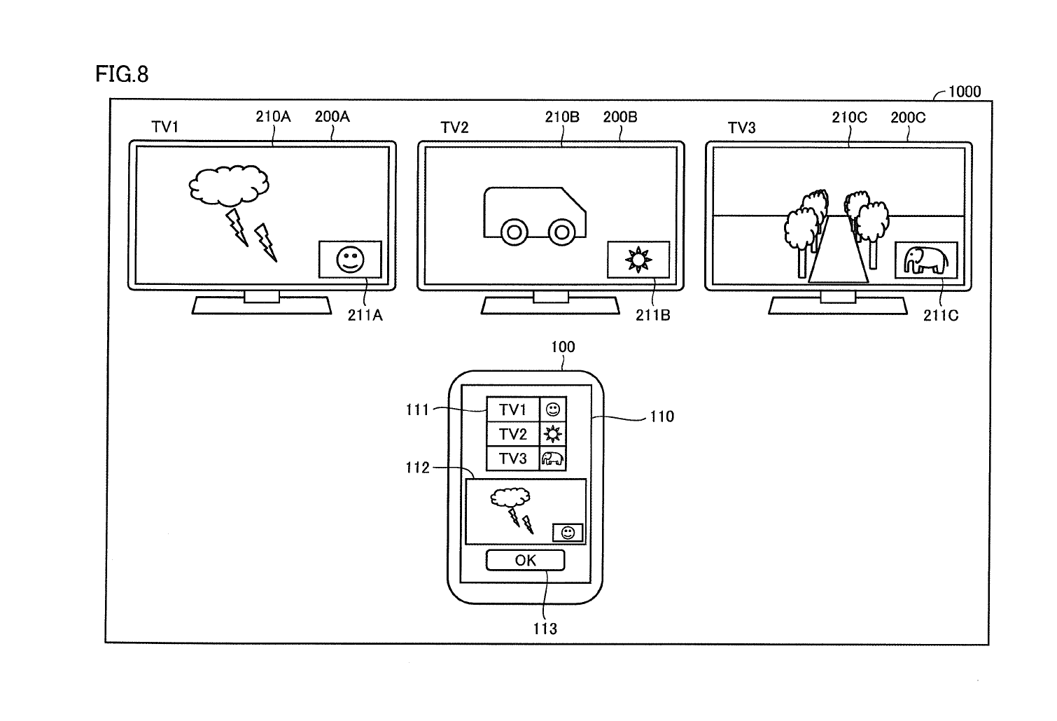

When an application for remote control is activated at control device 100, a notification start command is transmitted to under-control devices 200A, 200B and 200C via the network. In response, icons 211A, 211B and 211C are shown at display units 210A, 210B and 210C of under-control devices 200A, 200B and 200C in remote control system 1000, as shown in FIG. 8. By icons 211A, 211B and 211C showing information differing from each other (smiling face, sun, and elephant), the identification information for each of under-control devices 200A, 200B and 200C is displayed. At display unit 110 of control device 100, associated table 111 is displayed. Associated table 111 shows each name of under-control devices 200A, 200B and 200C (TV1, TV2, TV3) in association with the identification information of each device (smiling face, sun, elephant).

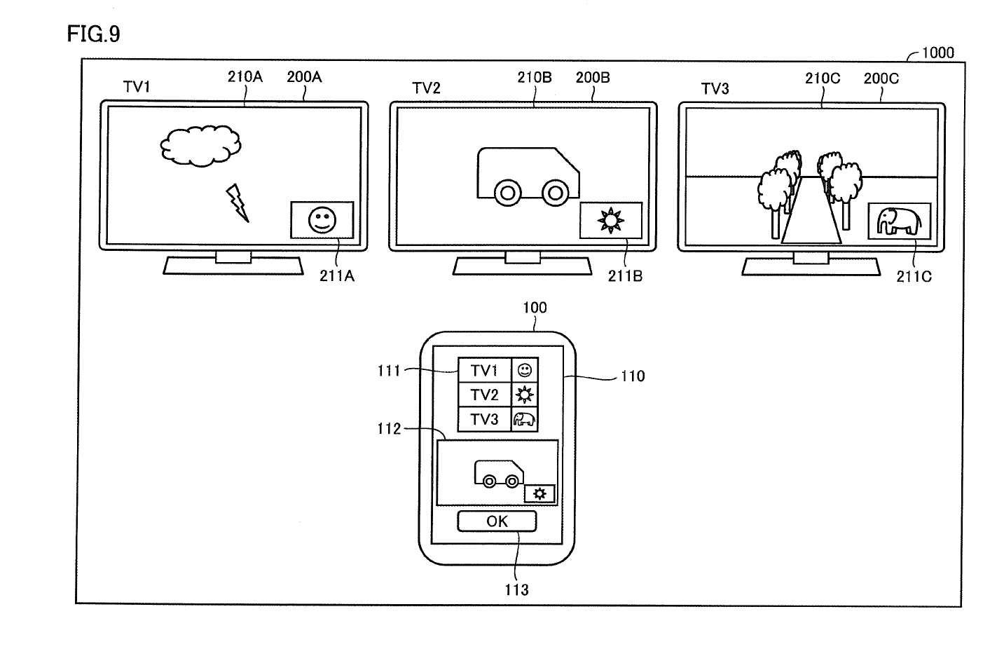

When one device is selected in associated table 111, the screen that is displayed at the selected device is shown at screen 112. Since under-control device 200A is selected in FIG. 8, the display screen of under-control device 200A is shown at screen 112. The device subject to selection in associated table 111 may be modified. Since under-control device 200B is selected in FIG. 9, the display screen of under-control device 200B is shown at screen 112.

When determination button 113 is manipulated under the state where one device is selected from associated table 111, the device selected at that point in time is determined to be the subject of remote control by control device 100. The screen of the operation corresponding to the subject of remote control is displayed at display unit 110 thereafter.

When an operation to modify the subject of remote control is carried out at control device 100, associated table 111 is displayed again at display unit 110. Then, the above-described process to determine the subject of remote control is carried out at control device 100.

When associated table 111 is displayed, control device 100 receives a presence informing signal and identification information from each of under-control devices 200A, 200B and 200C. When associated table 111 is displayed again, control device 100 receives a presence informing signal and identification information again to newly produce and display associated table 111.

<Contents of Remote Control Subject Determination Process>

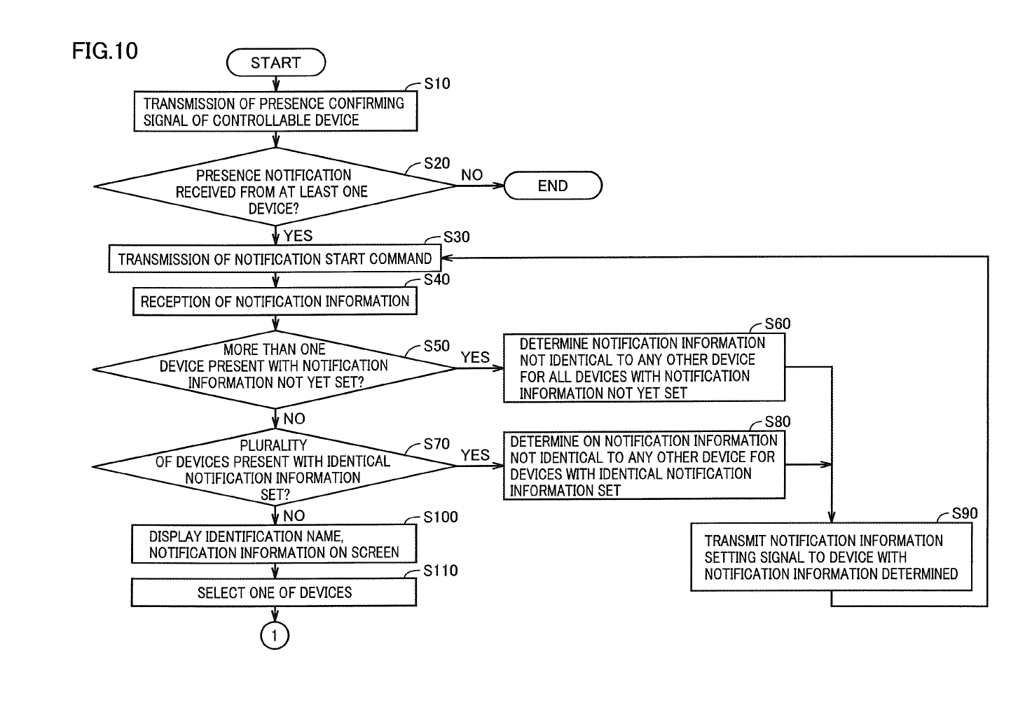

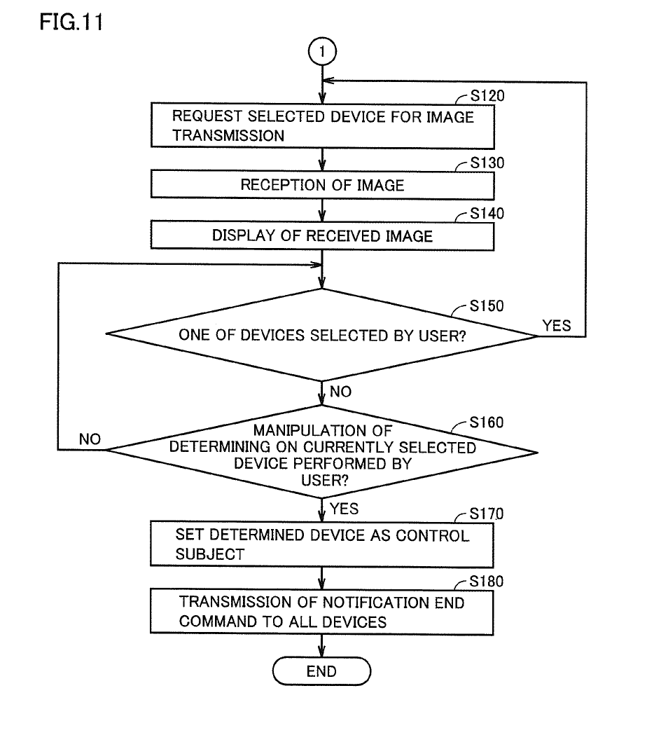

FIGS. 10 and 11 are flowcharts of a process executed for a remote control subject determination process at control device 100.

Referring to FIG. 10 first, upon activation of the application for remote control at control device 100, central processing device 150 executes a process to receive a presence informing signal (transmission of presence confirming signal) from an under-control device 200 on the network at step S10. Then control proceeds to step S20.

At step S20, central processing device 150 determines whether a presence informing signal has been received from one or more under-control devices 200. Upon determining reception, control proceeds to step S30. When a determination is made that a presence informing signal was not received from any one under-control device 200, the process is terminated. In the latter case, central processing device 150 may cause display unit 110 to display a message indicating that an under-control device that may become the subject of control is not present on the network.

At step S30, a notification start command is transmitted to under-control device 200 from which a presence informing signal is received. Then, control proceeds to step S40.

At step S40, central processing device 150 receives notification information (contents of identification information) from each under-control device 200. Then, control proceeds to step S50.

At step S50, central processing device 150 determines whether there is an under-control device 200 from which notification information could not be received at step S40, or whether there is an under-control device 200 whose information received at step S40 informs that notification information could not be set, among under-control devices 200 to which a notification start command is transmitted. When a determination is made that such an under-control device 200 is present, control proceeds to step S60. In contrast, when a determination is made that such an under-control device 200 is not present, central processing device 150 shifts the process to step S70.

At step S60, central processing device 150 sets identification information for an under-control device 200 from which notification information could not be received at step S40, and for an under-control device 200 whose information received at step S40 informs that notification information could not be set, such that different identification information is notified at all under-control devices 200. Then control proceeds to step S90.

At step S70, central processing device 150 determines whether the identification information received from each under-control device 200 at step S40 includes the same notification information (identification information). In other words, a determination is made as to whether there is duplication in the identification information from each under-control device 200. When central processing device 150 determines that there is identical identification information, control proceeds to step S80. In contrast, when central processing device 150 determines that identical identification information is not included, control proceeds to step S100.

At step S80, central processing device 150 sets identification information for a device (under-control device 200) having identical notification information (identification information) such that there is no overlapping identification information with any other device (under-control device 200) on the network. Then, control proceeds to step S90.

Following step S60, central processing device 150 may determine whether the identification information for the remaining under-control devices 200 overlaps at step S70, and make adjustment at step S80 such that the identification information, when overlapping, does not overlap.

At step S90, central processing device 150 transmits the identification information set at step S60 or step S80 to a corresponding under-control device 200. Then, control returns to step S30. Accordingly, identification information differing from each other among a plurality of under-control devices 200 is notified in the remote control system.

At step S100, central processing device 150 causes display unit 110 to show the identification name (model name and/or designation) of each under-control device 200 and the notification information (identification information) notified at each device, as shown in associated table 111. Then, control proceeds to step S110.

At step S110, central processing device 150 accepts manipulation to select one device (apparatus) from the devices displayed at associated table 111. Then, control proceeds to step S120.

At step S120 in FIG. 11, central processing device 150 requests for transmission of an operating state of a relevant device towards the apparatus (device) accepting selection at step S110 (or, at step S150 that will be described afterwards). Since each of under-control devices 200A, 200B and 200C is a television in the present embodiment, transmission of image information on the screen currently displayed at the relevant television is requested.

Then, central processing device 150 receives at step S130 the image requested at step S120.

At step S140, central processing device 150 causes display unit 110 to display the image received at step S130, such as screen 112 (FIG. 1 and the like). Then, control proceeds to step S150.

At step S150, central processing device 150 determines whether manipulation to select another apparatus (device) in associated table 111 is made or not. When a determination is made that such an operation is performed, control returns to step S120; otherwise, control proceeds to step S160.

At step S160, central processing device 150 determines whether manipulation to determine the currently selected apparatus (device) as the subject of remote control is performed or not. Manipulation on determination button 113 (FIG. 1 and the like) can be cited as an example of such manipulation. When central processing device 150 determines that such manipulation is performed, control proceeds to step S170; otherwise, control returns to step S150.

At step S170, central processing device 150 sets the apparatus (device) determined at step S160 as the subject of remote control. Then, control proceeds to step S180.

At step S180, a command to end notification of identification information (notification end command) is transmitted to all apparatuses (devices) to which a notification start command was transmitted at step S30. Then, the process is terminated.

Following termination of the process at step S180, control device 100 executes the well-known process as a remote controller, taking the apparatus (device) determined as set forth above as the subject of remote control.

When manipulation to modify the subject of remote control is performed at control device 100, the process from step S10 is executed again.

### Second Embodiment

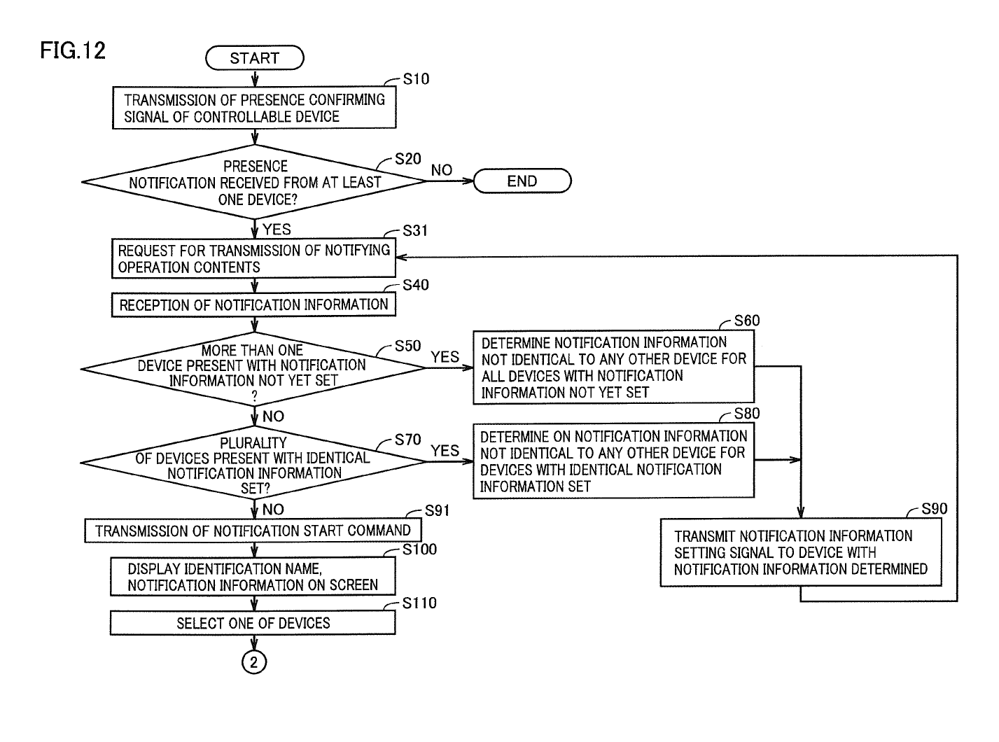

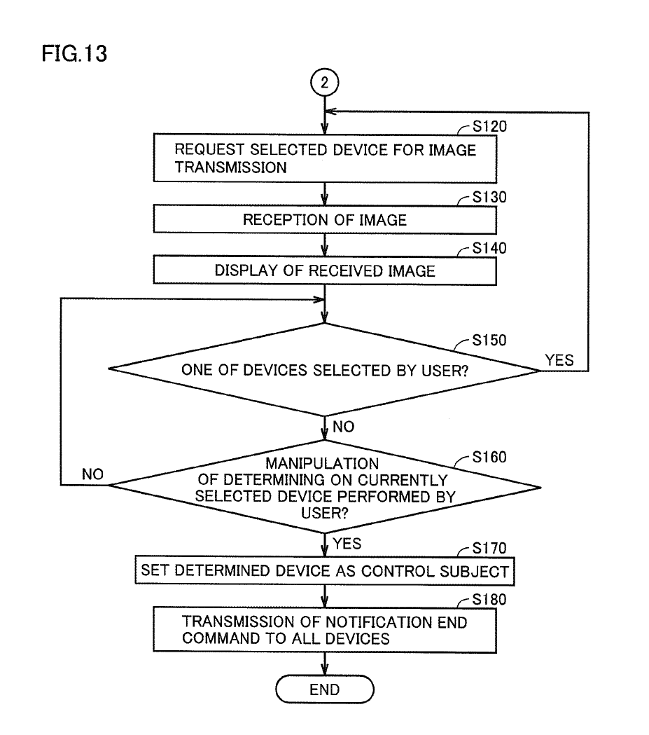

FIGS. 12 and 13 are flowcharts of a modification of the process indicated in FIGS. 10 and 11.

In the present modification, following reception of a presence informing signal in the process of FIG. 10, central processing device 150 ascertains the notification contents of each apparatus (device) and then transmits a notification start command, instead of immediately transmitting a notification start command at step S30.

Specifically, in the present modification, central processing device 150 receives a presence informing signal at step S20, and then control proceeds to step S31, as shown in FIG. 12.

At step S31, central processing device 150 requests each under-control device 200 from which a presence informing signal is received to transmit information to be notified as the identification information (notifying operation contents). Then, control proceeds to step S40.

At step S40, central processing device 150 receives the notifying operation contents from each under-control device 200. Then, control proceeds to step S50.

At steps S60-S80, when there is an under-control device 200 with notifying operation contents not yet set, or when there is a plurality of under-control devices 200 with overlapping notifying operation contents, the notifying operation contents are set such that there is no overlapping between under-control devices 200.

Thus by setting the notifying operation contents without duplication in all under-control devices 200, central processing device 150 transmits a notification start command to each under-control device 200 at step S91. In response, each under-control device 200 notifies the identification information set as the notifying operation contents.

The process of steps S100 and et seq. is similar to that described with reference to FIGS. 10 and 11. Therefore, overlapping description will not be repeated.

### Third Embodiment

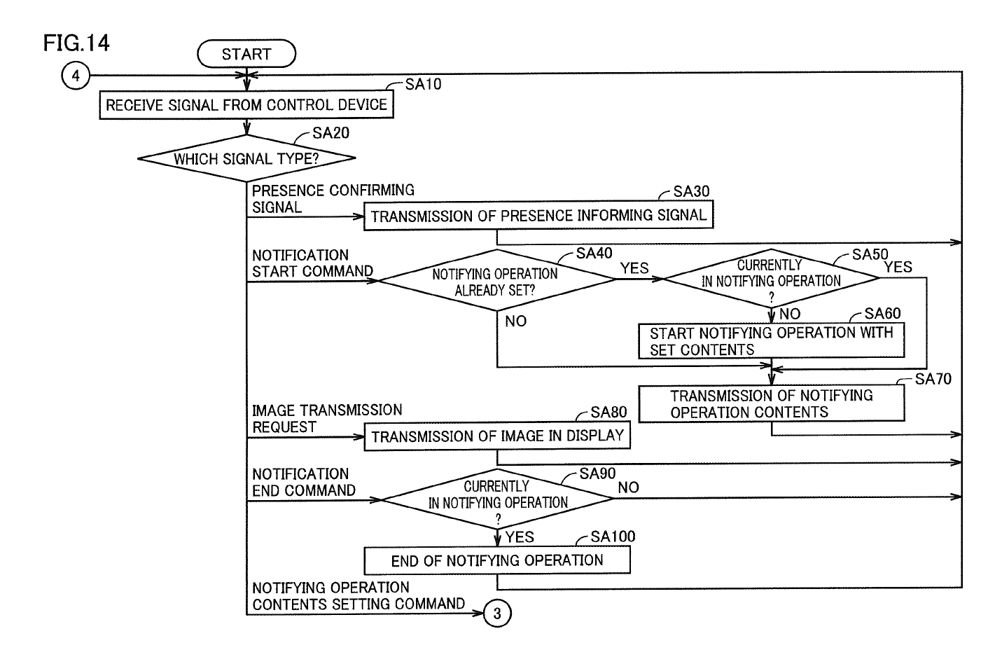

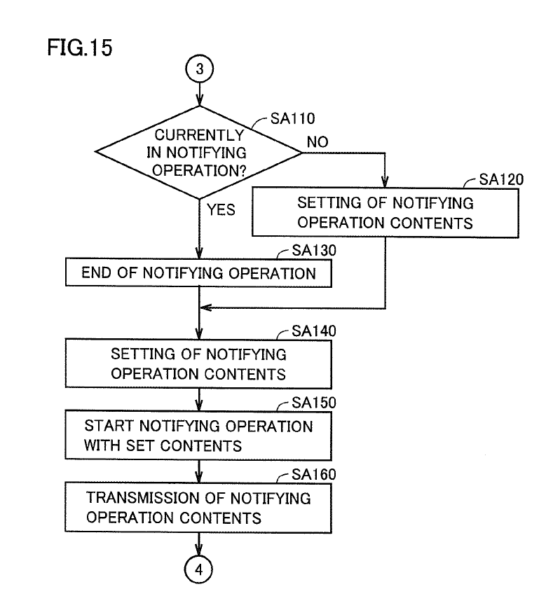

FIGS. 14 and 15 are flowcharts of a process executed at under-control device 200. The relevant process is executed when under-control device 200 has power turned ON or in a standby state. Under these states, under-control device 200 is always on standby for receiving a signal from control device 100.

Referring to FIG. 14 first, when central processing device 250 receives a signal transmitted from control device 100 at step SA10, control proceeds to step S20.

At step SA20, central processing device 250 determines the type of the signal received at step SA10. Then, central processing device 250 shifts the process to step SA30 in the case where the type of the received signal is a presence informing signal, to step SA40 in the case of a notification start command, to step S80 in the case of an image transmission request (signal transmitted from control device 100 to under-control device 200 at “7. Transmission of image transmission request” in FIG. 1), to step SA90 in the case of a notification end command, and to step SA110 in the case of a notifying operation contents setting command.

At step SA30, central processing device 250 transmits a presence informing signal. Then, control returns to step SA10.

At step SA40, central processing device 250 determines whether the contents of the notifying operation are set or not at a relevant under-control device 200. Under-control device 200 has the contents of the notifying operation set by storing image information to be notified as identification information in storage unit 260, for example. When central processing device 250 determines that the contents of the notifying operation are set, control proceeds to step SA50; otherwise, to step SA60.

At step SA50, central processing device 250 determines whether the notifying operation of identification information is currently executed at a relevant under-control device 200. Specifically, central processing device 250 makes this determination based on whether icon 211 is displayed at display unit 210. Control proceeds to step SA70 when a notifying operation is currently executed; otherwise control proceeds to step SA60.

At step SA60, notification of identification information is initiated according to the setting contents confirmed at step SA40. Then, control proceeds to step SA70.

At step SA70, central processing device 250 transmits the contents of the notifying operation set to control device 100. Then, control returns to step SA10. When a determination is made that the contents of the notifying operation is not set at step SA40, central processing device 250 transmits to control device 100 information indicating that the contents of the notifying operation are not set at step SA70.

At step SA80, central processing device 250 transmits the operation contents of a relevant under-control device 200 to control device 100. As a specific example of step SA80, central processing device 250 transmits the image displayed at display unit 110 to control device 100 (8. Image transmission in FIG. 1). Then, control returns to step SA10.

At step SA90, central processing device 250 determines whether a notifying operation of identification information is currently executed at a relevant under-control device 200. When a negative determination is made, control returns to step SA10. In contrast, when a determination is made that a notifying operation of identification information is currently executed, central processing device 250 ends the notifying operation at step SA100, and returns the process to step SA10. By the notifying operation at under-control device 200 being ended in the present embodiment, icons 211A, 211B and 211C displayed at display units 210A, 210B and 210C as shown in FIG. 8 are no longer displayed, as shown in FIG. 7.

At step SA110 in FIG. 15, central processing device 250 determines whether a notifying operation of identification information is currently executed. When the determination is affirmative, control proceeds to step SA130; otherwise, to step SA120.

At step SA120, central processing device 250 sets (for example, store in storage unit 160) the identification information transmitted from control device 100 together with a notifying operation contents setting command as the identification information of a relevant under-control device 200. Then, control proceeds to step SA150.

At step SA130, central processing device 250 ends the notifying operation of identification information currently executed, and shifts the process to step SA140.

At step SA140, central processing device 250 sets (for example, store in storage unit 160) the identification information transmitted from control device 100 together with a notifying operation contents setting command as the identification information of a relevant under-control device 200. Then, control proceeds to step SA150.

At step SA150, central processing device 250 initiates notification of the identification information set at step SA120 or step SA140 (for example, display of icons 211A, 211B, 211 and 211C). Then, control proceeds to step SA160.

At step SA160, central processing device 250 transmits the contents of the notification information started at step SA150 (contents of identification information and the like) to control device 100. Then, control returns to step SA10.

Thus, under-control device 200 executes a process corresponding to the signal transmitted from control device 100, as described above with reference to FIGS. 14 and 15.

### Fourth Embodiment

Under-control device 200 described in the third embodiment ended the notifying operation of identification information on condition that a notification end command transmitted from control device 100 is received. In contrast, under-control device 200 of the present embodiment ends an identification information notifying operation on condition that an arbitrary time has elapsed from the start of a relevant operation.

Specifically, in contrast to the third embodiment in which under-control device 200 executes a process to end the notifying operation in response to receiving a notification end command from control device 100 at step SA90 and step SA100 in FIG. 14, under-control device 200 of the present embodiment ends an identification information notifying operation on condition that an arbitrary time has elapsed from the start of a notifying operation, instead of receiving a notification end command.

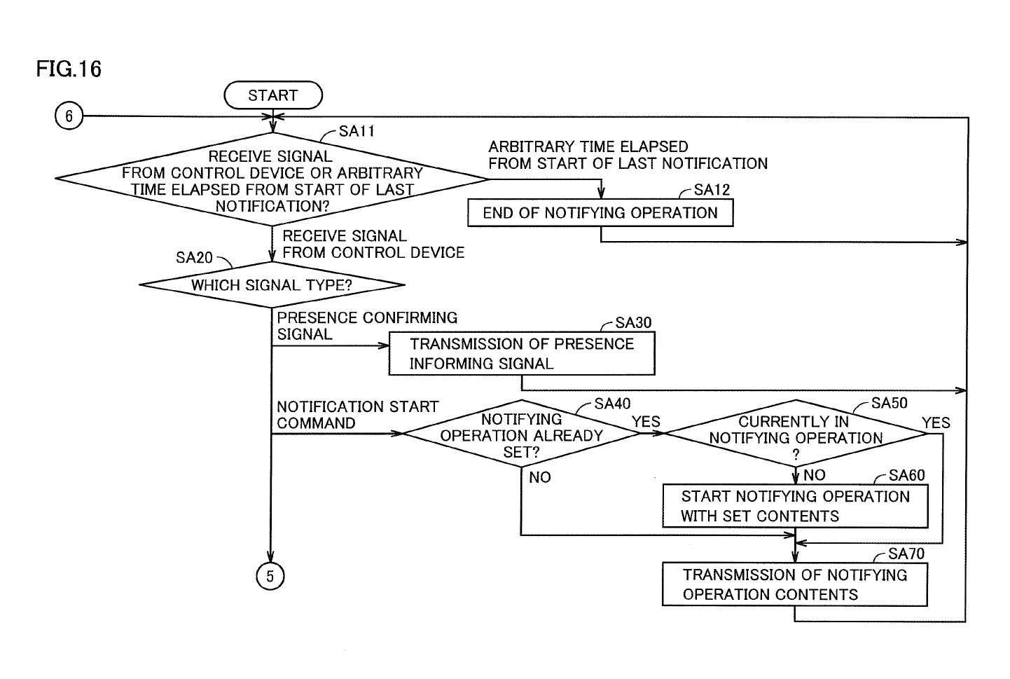

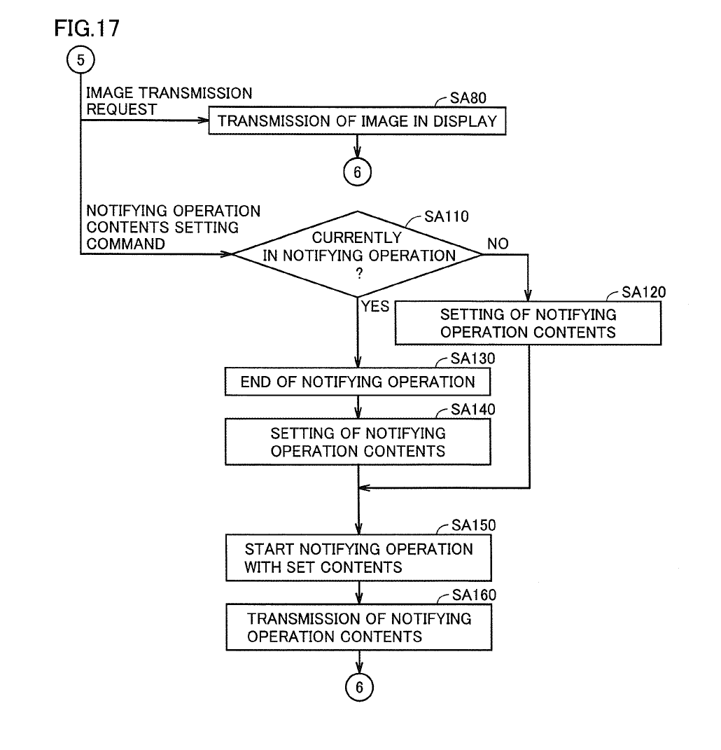

The contents of the process executed at under-control device 200 in the present embodiment will be described in further detail with reference to FIGS. 16 and 17. The relevant process is executed when under-control device 200 has power turned ON or in a standby state. Under these states, under-control device 200 is always on standby for receiving a signal from control device 100.

Referring to FIG. 16, central processing device 250 of the present embodiment determines at step SA11 whether a signal from control device 100 is received, or whether an arbitrary time has elapsed from the last start of an identification information notifying operation at under-control device 200. When a determination is made that an arbitrary time has elapsed from the start of the last notifying operation of identification information, control proceeds to step SA12; otherwise, when a determination is made that the signal from control device 100 has been received, control proceeds to step SA20.

At step SA12, central processing device 250 ends the currently-executed notifying operation of identification information. Then, control returns to step SA11.

At steps SA20-SA80 and steps SA110-SA160, central processing device 250 of the present embodiment executes an operation similar to that executed by central processing device 250 in the third embodiment. Therefore, duplicated description will not be repeated.

Central processing device 250 of the present embodiment may execute the process of step SA90 and step SA100 in response to receiving a notification end command from control device 100. Accordingly, when a notification end command is transmitted prior to elapse of an arbitrary time, the notifying operation of identification information can be terminated in a shorter time.

### Fifth Embodiment

Under-control device 200 described in the third embodiment sets the contents of identification information according to the contents transmitted from control device 100, when the contents of identification information in the notifying operation at relevant under-control device 200 are not set. In contrast, under-control device 200 of the present embodiment modifies and sets the contents of identification information to be notified by the host device even in such a case.

Specifically, when central processing device 250 determines that a notifying operation is not set at step SA40 in FIG. 14, under-control device 200 in the third embodiment informs control device 100 that the notifying operation is not set. Then, at step SA120 or step SA140 in FIG. 15, the contents specified as the identification information from control device 100 is set as the identification information.

In contrast, when a notifying operation is not set at the host device, or when the notifying operation overlaps with that of another under-control device 200, central processing device 250 of the present embodiment newly carries out the setting of identification information at the host device.

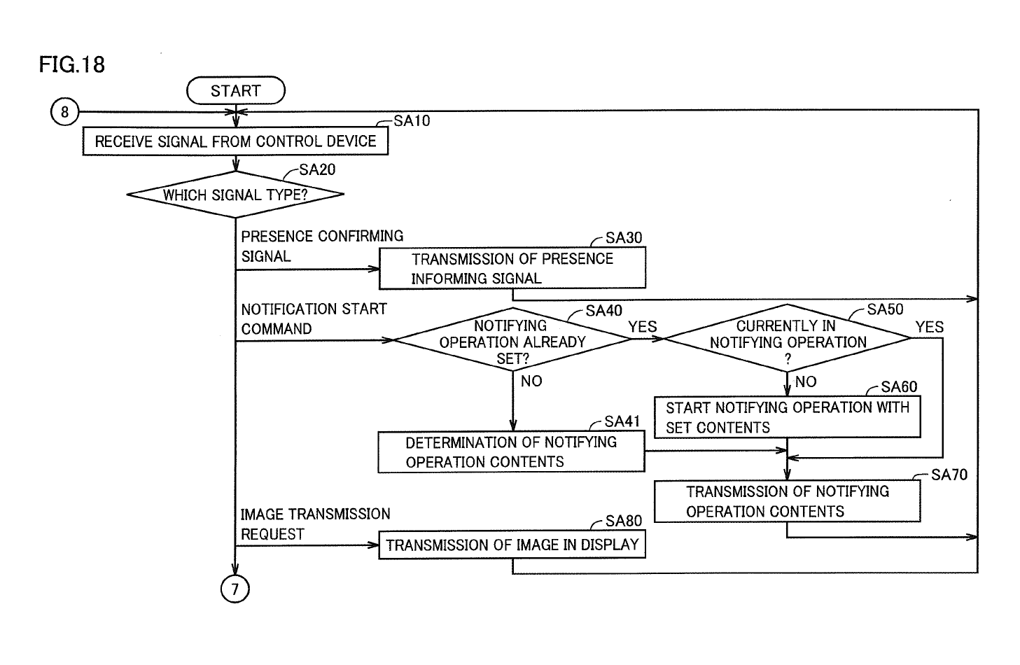

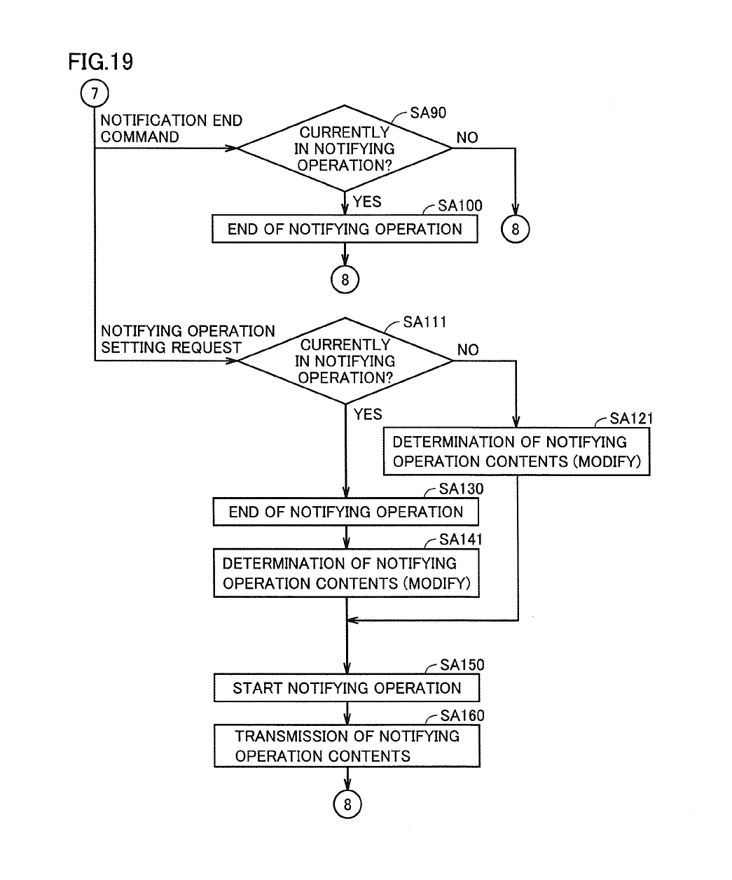

Referring to FIGS. 18 and 19, the contents of the process executed at under-control device 200 in the present embodiment will be described more specifically hereinafter. The relevant process is executed when under-control device 200 has power turned ON or in a standby state. Under these states, under-control device 200 is always on standby for receiving a signal from control device 100.

Referring to FIG. 18, likewise with central processing device 250 of the third embodiment, central processing device 250 of the present embodiment executes step SA10 and step SA20, and then determines whether the contents of the notifying operation are set at the host device. When a non-set determination is made, control proceeds to step SA41.

At step SA41, central processing device 250 sets the contents of the notifying operation. Then, control proceeds to step SA70. It is to be noted that at step SA41, central processing device 250 selects one information from the information (image information and the like) stored in advance as a candidate of identification information in storage unit 260, and sets (for example, store in storage unit 160) the selected information as the identification information in relevant under-control device 200.

At step SA70, central processing device 250 transmits the contents of the notifying operation started at step S60, or the contents of the notifying operation set at step SA41, to control device 100. Then, control returns to step SA10.

When identification information to be notified is not set at under-control device 200, or when the identification information notified at a plurality of under-control devices 200 overlaps, a “notifying operation setting request” is transmitted, instead of a notifying operation contents setting command. The notifying operation setting request instructs to newly set identification information at each under-control device 200. When central processing device 250 determines that the received signal from control device 100 is a notifying operation set request, control proceeds to step SA111.

Referring to FIG. 19, central processing device 250 determines at step SA111 whether its host device is currently executing an identification information notifying operation. When an identification information notifying operation is currently executed, control proceeds to step SA130; otherwise, to step SA121.

At step SA121, central processing device 250 modifies the contents of identification information from the currently set one to another one, and sets (for example, store in storage unit 160) the contents of the modified identification information. Then, control proceeds to step SA150.

At step SA130, central processing device 250 ends the currently executed notifying operation of identification information. Then, control proceeds to step SA141.

At step SA141, central processing device 250 modifies the contents of identification information from the currently set one to another one, and sets the contents of modified identification information (for example, store in storage unit 160). Then, control proceeds to step SA150.

At step SA150, central processing device 250 initiates the notifying operation of the identification information newly set at step SA121 or step SA141, and transmits the contents of the relevant notifying operation to control device 100 at step SA160. Then, control returns to step SA10.

According to the present embodiment set forth above, selecting and setting the contents of the notifying operation are carried out on the part of under-control device 200. In other words, control device 100 only has to determine whether there is overlapping identification information notified at a plurality of under-control devices 200. In the case where there is overlapping identification information, how the identification information is to be modified can be determined on the part of under-control device 200. Accordingly, the load required on the part of control device 100 can be distributed among under-control devices 200.

### Other Modifications

In each of the embodiments described above, under-control devices 200A, 200B and 200C in the remote control system are all of the same type (television). However, the type may differ from each other. In the case where a device other than a television is employed as under-control device 200, the relevant under-control device 200 notifies at least the identification information assigned to itself. The relevant notification is not limited to a display. For example, the contents of the image displayed at the icon in FIG. 1 such as “smile”, “sun”, and “elephant” may be provided in audio.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims. Moreover, the invention described in each of the embodiments and modifications is intended to be implemented individually or in combination, if possible.

### REFERENCE SIGNS LIST

100 control device; 110, 210, 210A, 210B, 210C display unit; 111 associated table; 112 screen; 113 determination button; 120, 220 manipulation unit; 121 manipulation button; 130, 230 communication unit; 140, 240 temporary storage unit; 150, 250 central processing device; 160, 260 storage unit; 191 presence informing signal reception unit; 192 instruction signal transmission unit; 193, 292 notification unit; 194 under-control device information storage unit; 195 input unit; 196 selection unit; 197 authentication processing unit; 200, 200A, 200B, 200C under-control device; 211, 211A, 211B, 211C icon; 270 audio output unit; 290 notification instruction reception unit; 291 presence informing signal transmission unit; 293 authentication information storage unit; 294 request transmission unit; 295 authentication unit; 296 notification contents storage unit; 297 notification information transmission unit; 298 notification control unit; 1000 remote control system.

1. A control device remotely controlling a plurality of under-control devices connected to a network, comprising:
a communication unit configured to receive a presence informing signal transmitted from a plurality of under-control devices qualified as a control subject and transmit to each under-control device from which a presence informing signal is received a signal instructing notification of information to identify a relevant under-control device;
a notification unit configured to notify information to be notified at each under-control device from which a presence informing signal is received;
a registration unit configured to register information to be notified at each under-control device from which a presence informing signal is received in association with each under-control device;
an input unit configured to enter an instruction to select one information from the information notified for each under-control device from which a presence informing signal is received; and
a control unit configured to select, as a subject of remote control, an under-control device registered at said registration unit in association with the information selected by the instruction to said input unit.

2. The control device according to claim 1, wherein said notification unit is configured to causes a display device to display information to be notified at each under-control device from which a presence informing signal is received in association with a character string including a model name of each under-control device, or in association with information entered at said input unit corresponding to a relevant under-control device.

3. The control device according to claim 1, wherein said communication unit is configured to transmit, when transmission of authentication information is requested from an under-control device, information entered at said input unit in response to said request to a relevant under-control device, and is configured to receive from the relevant under-control device permission information that is information indicating permission of remote control of the relevant under-control device, and
said selection unit is configured to selects an under-control device requesting for transmission of said authentication information as a subject of remote control on condition that said authentication processing unit has received said permission information.

4. The control device according to claim 3, wherein said communication unit is configured to transmit, for every under-control device, information entered at said input unit in response to a request for transmitting authentication information, and receive said permission information from a relevant under-control device.

5. The control device according to claim 1, wherein said communication unit is configured to obtains information of a power state of each under-control device from which a presence informing signal is received, and transmits a signal instructing notification of information to identify a relevant under-control device to only an under-control device that is powered up.

6. The control device according to claim 1, wherein said communication unit is configured to transmits to each under-control device from which a presence informing signal is received a signal instructing ending of said notification on condition that said control unit has selected an under-control device that is a subject of remote control.

7. The control device according to claim 1, wherein said communication unit is configured to receives, from each under-control device, information to be notified at each under-control device from which a presence informing signal is received, and
said registration unit is configured to registers information corresponding to the received information.

8. The control device according to claim 7, wherein said communication unit is configured to receives image information from each under-control device as information to be notified at each under-control device from which a presence informing signal is received.

9. The control device according to claim 1, wherein said communication unit is configured to transmits information to be notified at a relevant under-control device together with a signal instructing notification of information for identification to an under-control device.

10. The control device according to claim 9, wherein said communication unit is configured to transmits information differing from each under-control device as said information to be notified.

11. The control device according to claim 1, wherein said communication unit is configured to receives, from an under-control device, information to be notified at a relevant under-control device; and
said communication unit is configured to transmits, to at least one under-control device among said plurality of under-control devices, information differing from the notified information as information to be notified at the relevant under-control device when said information to be notified that is received from a plurality of under-control devices is identical.

12. An under-control device subject to remote control by a control device connected to a network, said under-control device comprising:
a communication unit configured to transmit a presence informing signal periodically onto said network; and
a notification unit configured to notify, on condition that a signal instructing notification of information to identify said under-control device has been received from said control device, relevant information.

13. The under-control device according to claim 12, further comprising:
an authentication information storage unit configured to store authentication information that is information to determine whether to permit a host device to be subject to remote control;
wherein said communication unit is configured to transmit information requesting for transmission of authentication information to said control device; and transmit permission information permitting the host device to be subject to remote control to said control device on condition that information received according to transmission of information by said request transmission unit from said control device matches said authentication information.

14. The under-control device according to claim 12, further comprising a notification contents storage unit configured to store information to be notified by said notification unit.

15. The under-control device according to claim 12 wherein said communication unit transmits information to be notified by said notification unit to said control device.

16. The under-control device according to claim 15, wherein said communication unit is configured to transmits image information as information to be notified by said notification unit.

17. The under-control device according to claim 12, further comprising a control unit configured to determine information to be notified by said notification unit in response to receiving said signal instructing notification from said control device.

18. The under-control device according to claim 12, wherein said communication unit is configured to receives information to identify said under-control device from said control device, and
said notification unit is configured to notifies the received information.

19. A remote control system comprising an under-control device, and a control device remotely controlling a relevant under-control device, connected to a network,
said under-control device including a first communication unit for transmitting a presence informing signal periodically onto said network,
said control device including a second communication unit configured to receive a presence informing signal transmitted from a plurality of under-control devices and
transmit to each under-control device from which a presence informing signal is received, a signal instructing notification of information to identify a relevant under-control device,
said under-control device further including a first notification unit configured to notify, on condition that a signal instructing notification of information to identify said under-control device has been received from said control device, relevant information,
said control device further including:
a second notification unit configured to notify information to be notified at each under-control device from which a presence informing signal is received;
a registration unit configured to register information to be notified at each under-control device from which a presence informing signal is received in association with each under-control device;
an input unit configured to enter an instruction to select one information from the information notified by said second notification unit for each under-control device from which a presence informing signal is received; and
a selection unit configured to select, as a subject of remote control, an under-control device registered at said registration unit in association with the information selected by the instruction to said input unit.

20. A control method of a control device executed by a computer controlling the control device remotely controlling a plurality of under-control devices connected to a network, said method comprising the steps of:
receiving a presence informing signal transmitted from a plurality of under-control devices qualified as a control subject;
transmitting to each under-control device from which a presence informing signal is received a signal instructing notification of information to identify a relevant under-control device;
notifying information to be notified at each under-control device from which a presence informing signal is received;
registering information to be notified at each under-control device from which a presence informing signal is received in association with each under-control device;
entering an instruction to select one information from information notified at each under-control device from which a presence informing signal is received; and
selecting, as a subject of remote control, an under-control device registered in association with information selected by said instruction entered.

21. A control method of an under-control device, executed by a computer controlling an under-control device subject to remote control by a control device connected to a network, said method comprising the steps of:
transmitting a presence informing signal periodically onto said network;
receiving from said control device a signal instructing notification of information to identify said under-control device; and
notifying said information on condition that said signal instructing notification has been received.

22. A non-transitory recording medium on which is stored a control program for a control device remotely controlling a plurality of under-control devices connected to a network, said control program executed by a computer controlling said control device,
said control program causing said computer to execute the steps of:
receiving a presence informing signal transmitted from a plurality of under-control devices qualified as a control subject;
transmitting to each under-control device from which a presence informing signal is received a signal instructing notification of information to identify a relevant under-control device;
notifying information to be notified at each under-control device from which a presence informing signal is received;
registering information to be notified at each under-control device from which a presence informing signal is received in association with each under-control device;
entering an instruction to select one information from information notified at each under-control device from which a presence informing signal is received; and
selecting, as a subject of remote control, an under-control device registered in association with the information selected by said instruction entered.

23. A non-transitory recording medium on which is stored a control program for an under-control device subject to remote control by a control device connected to a network, said control program executed by a computer controlling said under-control device,
said control program causing said computer to execute the steps of:
transmitting a presence informing signal periodically onto said network;
receiving from said control device a signal instructing notification of information to identify said under-control device; and
notifying said information on condition that said signal instructing notification has been received.
